(19) United States
(12) Patent Application Publication
(10) Pub. No.: US 2007/0187033 A1
(43) Pub. Date: Aug. 16, 2007

(54) Contact adhesive for pvc films

(75) Inventors: Karl-Heinz Schumacher, Neustadt (DE); Nok-young Choi, Ludwigshafen (DE); Andree Dragon, Speyer (DE); Heiko Diehl, Fussgonheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/593,069

(22) PCT Filed: Apr. 14, 2005
(86) PCT No.: PCT/EP05/03918

§ 371 Date: Sep. 15, 2006

(30) Foreign Application Priority Data
Apr. 19, 2004 (DE) 10 2004 019 433.5

(51) Int. Cl. C09D 5/02; B32B 27/00

(52) U.S. Cl. 156/332; 524/556; 524/571

(57) ABSTRACT

An adhesive comprising a polymer obtainable by free-radical addition polymerization of ethylenically unsaturated compounds (monomers) and synthesized from at least 60% by weight of principal monomers selected from C1 to C20 alkyl (meth)acrylates, vinyl esters of carboxylic acids containing up to 20 carbon atoms, vinylaromatics having up to 20 carbon atoms, ethylenically unsaturated nitrites, vinyl halides, vinyl ethers of alcohols containing 1 to 10 carbon atoms, aliphatic hydrocarbons having 2 to 4 carbon atoms and one or two double bonds, and mixtures of these monomers, and from more than 1% by weight of monomers containing at least two nonconjugated polymerizable vinyl groups.

The invention relates to an adhesive comprising
a polymer obtainable by free-radical addition polymerization of ethylenically unsaturated compounds (monomers) and synthesized from at least 60% by weight of principal monomers selected from
C1 to C20 alkyl (meth)acrylates, vinyl esters of carboxylic acids containing up to 20 carbon atoms, vinylaromatics having up to 20 carbon atoms, ethylenically unsaturated nitrites, vinyl halides, vinyl ethers of alcohols containing 1 to 10 carbon atoms, aliphatic hydrocarbons having 2 to 4 carbon atoms and one or two double bonds, and mixtures of these monomers, and
from more than 1% by weight of monomers containing at least two nonconjugated polymerizable vinyl groups.

The invention further relates to the use of the adhesives for producing self-adhesive articles with plasticized PVC as backing material.

For exterior applications it is common to use self-adhesive labels and tapes and also printed films comprising plasticized PVC as their backing material. Plasticized PVC films contain low molecular mass, phthalate-based plasticizers or polymeric plasticizers. One problem which may occur as a result of using these plasticizers is plasticizer migration from the film into the pressure sensitive adhesive (PSA). This detracts from adhesive performance. Not only the cohesion of the adhesive but also its adhesion to the surface to which the label or film is adhered are reduced, generally significantly, by the migration of the plasticizer into the adhesive.

In the exterior sector, the self-adhesive articles are also subject to the influence of moisture.

The action of water on the film of adhesive results in an unwanted white haze, also called blushing.

In self-adhesive articles featuring polymer film backing material, particularly plasticized PVC backing material, contraction of the film in the course of subsequent use is a frequent occurrence. Contraction is observable particularly if the self-adhesive articles in use are exposed to elevated temperatures.

There is therefore a desire for adhesives that produce self-adhesive articles having improved contraction behavior.

Adhesives for producing self-adhesive articles with plasticized PVC backing material are known for example from DE-A-10229733 (PF 53677) and DE-A-10345799 (PF 54935). They are also described in EP-A-454426 and EP-A-978551. WO 93/14161 discloses polymers containing not more than 1 % of internal crosslinker for this utility.

An object of the present invention were therefore adhesives for self-adhesive articles with minimal contraction and maximum water resistance (blushing). The adhesives ought also to have good adhesion and cohesion and to have good processing properties.

Accordingly the adhesives defined at the outset and their use have been found.

The adhesive of the invention comprises the polymer defined above.

The polymer is obtainable by free-radical addition polymerization of ethylenically unsaturated compounds (monomers).

The polymer is composed of at least 60%, preferably at least 80%, more preferably at least 90% by weight of what are called principal monomers.

The principal monomers are selected from C₁-C₂₀ alkyl (meth)acrylates, vinyl esters of carboxylic acids containing up to 20 carbon atoms, vinylaromatics having up to 20 carbon atoms, ethylenically unsaturated nitriles, vinyl halides, vinyl ethers of alcohols containing 1 to 10 carbon atoms, aliphatic hydrocarbons having 2 to 8 carbon atoms and one or two double bonds, and mixtures of these monomers.

Examples that may be mentioned include (meth)acrylic acid alkyl esters having a C₁-C₁₀ alkyl radical, such as methyl methacrylate, methyl acrylate, n-butyl acrylate, ethyl acrylate and 2-ethylhexyl acrylate.

Mixtures of the (meth)acrylic acid alkyl esters in particular are also suitable.

Examples of vinyl esters of carboxylic acids having 1 to 20 carbon atoms include vinyl laurate, vinyl stearate, vinyl propionate, Versatic acid vinyl esters, and vinyl acetate.

Suitable vinylaromatic compounds include vinyltoluene, α- and p-methylstyrene, α-butylstyrene, 4-n-butylstyrene, 4-n-decylstyrene and, preferably, styrene. Examples of nitriles are acrylonitrile and methacrylonitrile.

The vinyl halides are chlorine-, fluorine- or bromine-substituted ethylenically unsaturated compounds, preferably vinyl chloride and vinylidene chloride.

Examples of vinyl ethers include vinyl methyl ether and vinyl isobutyl ether. Preference is given to vinyl ethers of alcohols containing 1 to 4 carbon atoms.

As hydrocarbons having 4 to 8 carbon atoms and one or two olefinic double bonds mention may be made of ethylene, propylene, butadiene, isoprene, and chloroprene.

Preferred principal monomers are the C₁ to C₁₀ alkyl acrylates and methacrylates, especially C₁ to C₈ alkyl acrylates and methacrylates, and vinylaromatics, especially styrene, and mixtures thereof.

Very particular preference is given to methyl acrylate, methyl methacrylate, ethyl acrylate, n-butyl acrylate, n-hexyl acrylate, octyl acrylate and 2-ethylhexyl acrylate, styrene, and mixtures of these monomers.

An essential feature of the invention is that the polymer is synthesized from more than 1% by weight of monomers containing at least two nonconjugated polymerizable vinyl groups (referred to below for short as internal crosslinkers). Preferred vinyl groups are acrylic and methacrylic groups. Mention may be made, by way of example, of the following: divinylbenzene.

Particular preference is given to alkanediol diacrylates or alkanediol di(meth)acrylates.

Very particular preference is given to butanediol diacrylate or butanediol dimethacrylate or to hexanediol diacrylate or hexanediol dimethacrylate.

The amount of internal crosslinkers is preferably at least 1.1%, in particular at least 1.2%, by weight; the amount is generally not more than 5% and in particular not more than 3% by weight, based in each case on the polymer.

Besides the principal monomers and internal crosslinkers the polymer may comprise further monomers, examples being monomers containing carboxylic acid, sulfonic acid or phosphonic acid groups. Carboxylic acid groups are preferred. Examples that may be mentioned include acrylic acid, methacrylic acid, itaconic acid, maleic acid, and fumaric acid.

Further monomers are, for example, monomers also containing hydroxyl groups, especially C₁-C₁₀ hydroxyalkyl (meth)acrylates, and (meth)acrylamide.

Further monomers that may be mentioned additionally are phenyloxyethyl glycol mono(meth)acrylate, glycidyl acrylate, glycidyl methacrylate, and amino (meth)acrylates such as 2-aminoethyl (meth)acrylate.

The polymer preferably comprises hydrophilic groups selected from carboxyl groups, hydroxyl groups, amino groups and carboxamide groups. The amount of these hydrophilic groups is in particular from 0.001 to 0.5 mol per 100 g of polymer. Preferably the amount is at least 0.005 mol, more preferably at least 0.008 mol and not more than 0.2 mol, in particular not more than 0.1 mol, with very particular preference not more than 0.05 or 0.03 mol, per 100 g/polymer.

Particular preference is given to the hydrophilic groups, selected from carboxyl groups, hydroxyl groups and carboxamide groups.

With particular preference at least 20 mol % of the overall molar amount of these hydrophilic groups is accounted for by carboxyl groups.

By carboxyl groups are meant not only carboxylic acid groups but also salts thereof. Where salts are concerned they are preferably salts with volatile bases, e.g., ammonia.

The hydrophilic groups can be attached to the polymer by copolymerization of the corresponding monomers.

Preferred monomers containing hydrophilic groups are the abovementioned monomers containing carboxyl groups and hydroxyl groups, acrylic acid being one particular example.

In particular the polymer is synthesized from at least 60%, more preferably at least 80% and very preferably at least 90% by weight of C₁ to C₂₀ alkyl (meth)acrylates.

In one preferred embodiment the polymers are prepared by emulsion polymerization, and the product is therefore an emulsion polymer.

In the case of emulsion polymerization, use is made of ionic and/or nonionic emulsifiers and/or protective colloids and/or stabilizers as surface-active compounds.

A detailed description of suitable protective colloids can be found in Houben-Weyl, Methoden der organischen Chemie, Volume XIV/1, Makromolekulare Stoffe [Macromolecular compounds], Georg-Thieme-Verlag, Stuttgart, 1961, pp. 411 to 420. Suitable emulsifiers include anionic, cationic, and nonionic emulsifiers. As accompanying surface-active substances it is preferred to use exclusively emulsifiers, whose molecular weights, unlike those of the protective colloids, are normally below 2000 g/mol. Where mixtures of surface-active substances are used, the individual components must of course be compatible with one another, something which in case of doubt can be checked by means of a few preliminary tests. It is preferred to use anionic and nonionic emulsifiers as surface-active substances. Common accompanying emulsifiers are, for example, ethoxylated fatty alcohols (EO units: 3 to 50, alkyl: C8 to C₃₆), ethoxylated mono-, di-, and tri-alkylphenols (EO units: 3 to 50, alkyl: C₄ to C₉), alkali metal salts of dialkyl esters of sulfosuccinic acid, and also alkali metal salts and ammonium salts of alkyl sulfates (alkyl: C₈ to C₁₂), of ethoxylated alkanols (EO units: 4 to 30, alkyl: C₁₂ to C₁₈), of ethoxylated alkylphenols (EO units: 3 to 50, alkyl: C₄ to C₉), of alkylsulfonic acids (alkyl: C₁₂ to C₁₈), and of alkylarylsulfonic acids (alkyl: C₉ to C₁₈).

Further suitable emulsifiers are compounds of the formula II 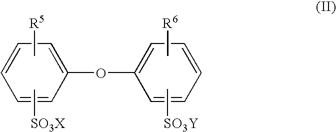
where R⁵ and R⁶ are hydrogen or C₄ to C₁₄ alkyl but are not simultaneously hydrogen, and X and Y can be alkali metal ions and/or ammonium ions. With preference, R⁵ and R⁶ are linear or branched alkyl radicals having from 6 to 18 carbon atoms or hydrogen and in particular have 6, 12 or 16 carbon atoms, R⁵ and R⁶ not both simultaneously being hydrogen. X and Y are preferably sodium, potassium or ammonium ions, sodium being particularly preferred. Particularly advantageous compounds 11 are those in which X and Y are sodium, R⁵ is a branched alkyl radical of 12 carbon atoms, and R⁶ is hydrogen or R⁵. It is common to use technical-grade mixtures containing a fraction of from 50 to 90% by weight of the monoalkylated product, one example being Dowfax® 2A1 (trade mark of the Dow Chemical Company).

Suitable emulsifiers can also be found in Houben-Weyl, Methoden der organischen Chemie, Volume 14/1, Makromolekulare Stoffe, Georg Thieme Verlag, Stuttgart, 1961, pages 192 to 208.

Examples of emulsifier trade names are Dowfax®2 A1, Emulan® NP 50, Dextrol® OC 50, Emulgator 825, Emulgator 825 S, Emulan® OG, Texapon® NSO, Nekanil® 904 S, Lumiten® I-RA, Lumiten® E 3065, Disponil FES 77, Lutensol® AT 18, Steinapol VSL, and Emulphor NPS 25.

For the present invention preference is given to ionic emulsifiers or protective colloids. Ionic emulsifiers are particularly preferred, especially salts and acids, such as carboxylic acids, sulfonic acids, and sulfates, sulfonates or carboxylates.

The surface-active substance is usually used in amounts from 0.1 to 10 parts by weight, preferably 0.2 to 5 parts by weight, per 100 parts by weight of the monomers to be polymerized.

Water-soluble initiators for the emulsion polymerization are, for example, ammonium salts and alkali metal salts of peroxodisulfuric acid, e.g., sodium peroxodisulfate, hydrogen peroxide, or organic peroxides, e.g., tert-butyl hydroperoxide.

Also suitable are what are known as reduction-oxidation (redox) initiator systems.

The redox initiator systems are composed of at least one, usually inorganic reducing agent and one organic or inorganic oxidizing agent.

The oxidizing component comprises, for example, the emulsion polymerization initiators already mentioned above.

The reducing component comprises, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Examples of customary redox initiator systems include ascorbic acid/iron(II) sulfate/sodium peroxodisulfate, tert-butyl hydroperoxide/sodium disulfite, and tert-butyl hydroperoxide/Na hydroxymethanesulfinate. The individual components, the reducing component for example, may also be mixtures: for example, a mixture of the sodium salt of hydroxymethanesulfinic acid with sodium disulfite.

These compounds are mostly used in the form of aqueous solutions, the lower concentration being determined by the amount of water that is acceptable in the dispersion and the upper concentration by the solubility of the respective compound in water. The concentration is generally from 0.1 to 30% by weight, preferably from 0.5 to 20% by weight, with particular preference from 1.0 to 10% by weight, based on the solution.

The amount of the initiators is generally from 0.1 to 10% by weight, preferably from 0.5 to 5% by weight, based on the monomers to be polymerized. It is also possible for two or more different initiators to be used for the emulsion polymerization.

For the polymerization it is possible to use regulators, in amounts for example of from 0 to 0.8 part by weight per 100 parts by weight of the monomers to be polymerized.

These regulators reduce the molar mass. Suitable examples include compounds containing a thiol group, such as tert-butyl mercaptan, thioglycolic acid ethylacrylic ester, mercaptoethynol, mercaptopropyltrimethoxysilane, and tert-dodecyl mercaptan.

The emulsion polymerization takes place in general at from 30 to 130° C., preferably from 50 to 90° C. The polymerization medium may be composed either of water alone or of mixtures of water and water-miscible liquids such as methanol. Preferably, only water is used. The emulsion polymerization may be conducted either as a batch operation or in the form of a feed process, including staged or gradient procedures. Preference is given to the feed process in which a portion of the polymerization mixture is introduced as an initial charge and heated to the polymerization temperature, the polymerization of this initial charge is begun, and then the remainder of the polymerization mixture is supplied to the polymerization zone, usually by way of two or more spatially separate feed streams, of which one or more contain the monomers in straight or emulsified form, this addition being made continuously, in stages or under a concentration gradient, and polymerization being maintained during said addition. It is also possible, in order, for example, to set the particle size more effectively, to include a polymer seed in the initial charge for the polymerization.

The manner in which the initiator is added to the polymerization vessel in the course of the free-radical aqueous emulsion polymerization is known to the skilled worker. It may either be included in its entirety in the initial charge to the polymerization vessel or else introduced, continuously or in stages, at the rate at which it is consumed in the course of the free-radical aqueous emulsion polymerization. In each specific case this will depend both on the chemical nature of the initiator system and on the polymerization temperature. It is preferred to include one portion in the initial charge and to supply the remainder to the polymerization zone at the rate at which it is consumed.

In order to remove the residual monomers, it is common to add initiator after the end of the actual emulsion polymerization as well, i.e., after a monomer conversion of at least 95%.

With the feed process, the individual components can be added to the reactor from the top, through the side, or from below, through the reactor floor.

In the case of emulsion polymerization, aqueous polymer dispersions with solids contents of generally from 15 to 75% by weight, preferably from 40 to 75% by weight, are obtained.

For a high reactor space/time yield, dispersions with as high as possible a solids content are preferred. In order to be able to achieve solids contents >60% by weight, a bimodal or polymodal particle size ought to be set, since otherwise the viscosity becomes too high and the dispersion can no longer be handled. Producing a new generation of particles can be done, for example, by adding seed (EP 81083), by adding excess quantities of emulsifier, or by adding miniemulsions. Another advantage associated with the low viscosity at high solids content is the improved coating behavior at high solids contents. One or more new generations of particles can be produced at any point in time. It is guided by the particle size distribution which is targeted for a low viscosity.

The polymer thus prepared is used preferably in the form of its aqueous dispersion.

The mean particle size of the polymer particles dispersed in the aqueous dispersion is preferably less than 300 nm, in particular less than 200 nm. With particular preference the mean particle size is between 140 and 200 nm.

By mean particle size here is meant the d₅₀ value of the particle size distribution; in other words 50% by weight of the total mass of all particles have a particle diameter smaller than the d₅₀ value. The particle size distribution can be determined in a known way using the analytical ultracentrifuge (W. Matschtle, Makromolekulare Chemie 185 (1984), page 1025-1039).

The pH of the polymer dispersion is preferably adjusted to a pH of more than 4.5, in particular to a pH between 5 and 8.

The glass transition temperature of the polymer, or of the polymer, is preferably from −60 to 0° C., with particular preference from −60 to −10° C, and with very particular preference from −60 to −20° C.

The glass transition temperature can be determined by customary methods such as differential thermoanalysis or differential scanning calorimetry (see, for example, ASTM 3418/82, midpoint temperature).

The adhesives, preferably pressure sensitive adhesives, may be composed solely of the polymer or of the aqueous dispersion of the polymer.

The adhesive requires no external crosslinkers. The amount of external crosslinkers is therefore generally less than 0.5 part by weight per 100 parts by weight of polymer, and in particular less than 0.1 part by weight. With particular preference external crosslinkers are omitted entirely.

The adhesives and PSAs may comprise further additives: fillers, colorants, flow control agents, thickeners or tackifiers (tackifying resins). Examples of tackifiers are natural resins, such as rosins and their derivatives formed by disproportionation or isomerization, polymerization, dimerization and/or hydrogenation. They may be present in their salt form (with, for example, monovalent or polyvalent counterions (cations)) or, preferably, in their esterified form. Alcohols used for the esterification may be monohydric or polyhydric. Examples are methanol, ethanediol, diethylene glycol, triethylene glycol, 1,2,3-propanethiol, and pentaerythritol.

Also used are hydrocarbon resins, e.g., coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, a-methylstyrene, and vinyltoluene.

Other compounds increasingly being used as tackifiers include polyacrylates which have a low molar weight. These polyacrylates preferably have a weight-average molecular weight M, of less than 30 000. With preference the polyacrylates are composed of at least 60% by weight, in particular at least 80% by weight, of C₁-C₈ alkyl (meth)acrylates.

Preferred tackifiers are natural or chemically modified rosins. Rosins are composed predominantly of abietic acid or its derivatives.

The amount by weight of tackifiers is preferably from 5 to 100 parts by weight, with particular preference from 10 to 50 parts by weight, per 100 parts by weight of polymer (solids/solids).

The adhesive or PSA is especially suitable for joining substrates, at least one of the substrate surfaces to be joined being made of plasticized PVC. For example, the adhesive may be applied to a backing, made of paper or plastic, for example, and the backing thus coated (e.g., a label, adhesive tape or film) may be bonded to a substrate made of plasticized PVC.

The adhesives or PSAs of the invention are especially suitable for producing self-adhesive articles, such as labels, adhesive tapes or adhesive films, e.g., protective films.

The self-adhesive articles are generally composed of a backing with a layer of the adhesive applied to one or both sides, preferably to one side.

The backing material may comprise, for example, paper, preferably polymer films made of polyolefins or PVC, more preferably PVC, and with particular preference plasticized PVC.

By plasticized PVC is meant polyvinyl chloride which includes plasticizers and has a reduced softening temperature. Examples of customary plasticizers include phthalates, epoxides, and adipates. The amount of plasticizers in the plasticized PVC is generally more than 10% by weight and in particular more than 20% by weight.

With plasticized PVC, plasticizers can migrate into the film of adhesive and significantly impair its properties. With the adhesive of the invention, plasticizer migration has virtually no effect, if any at all, on the properties of the adhesive. Moreover, particularly in the case of plasticized PVC, contraction of the substrates is prevented or reduced by the adhesive of the invention.

The present invention accordingly provides, in particular, self-adhesive articles comprising plasticized PVC backing material with, coated thereon, an adhesive layer comprising the above adhesive.

To produce the layer of adhesive on the backing material, the backing material can be coated conventionally.

The coated substrates obtained are used, for example, as self-adhesive articles, such as labels, adhesive tapes or films.

The self-adhesive articles comprising plasticized PVC backing material are particularly suitable for exterior applications.

In particular, printed self-adhesive films can be used in the exterior sector and can be adhered, for example, to advertizing boards or vehicles of all kinds.

The self-adhesive articles of the invention have good performance properties, in particular a good peel strength (adhesion) and shear strength (cohesion). The properties remain good even where the backing material is plasticized PVC.

Haziness in the layer of adhesive as a result of moisture exposure (i.e., blushing) is observed barely if at all. Consequently, the layer of adhesive is highly water resistant. Virtually no contraction of the self-adhesive articles is observable, even when the articles are exposed to high temperatures, e.g., more than 50° C.

### EXAMPLES

Test methods

Dimensional Stability (Contraction Behavior):

To determine the dimensional stability by the cross-cut method the adhesives are coated onto silicone paper (Laufenberg NSA 1370 white coating 56 B 4) at a rate of 25 g/m² dry. After drying at 90° C. for 3 minutes the adhesive layer is transferred onto plasticized PVC film (Renolit white, SK-Monomer 80790). After 24 h of storage at room temperature the silicone paper is peeled off and the coated plasticized PVC film is bonded without bubbles to a glass plate (25 cm×25 cm) and rolled on. It is important that the running direction of the film is noted and marked. The bonded film is then divided, using a razorblade in a blade mount, in the center in the lengthwise and crosswise directions, making one cut in each case. When cutting is complete there should be four squares of equal size. The glass plates are subsequently stored at 70° C. After 3 days the glass plates are cooled at RT for about 1 hour and the width of the cut gap in the cold state is measured.

The smaller the gap width, the better the contraction behavior.

Peel Strength

Plasticized PVC was coated with adhesive as described above.

Thereafter the peel strength (adhesion) was measured.

The coated backing was cut into test strips 25 mm wide.

For the determination of the peel strength (adhesion), a 2.5 cm wide test strip was adhered in each case to a steel test element and was rolled on once with a roller weighing 1 kg. After 1 minute or 24 hours of storage under standard conditions it was clamped by one end into the upper jaws of a tension-elongation testing apparatus. The adhesive strip was peeled from the test area at an angle of 180° and a speed of 300 mm/min; in other words, the adhesive strip was bent over and peeled off parallel to the metal test panel, and the force required to do this was measured. The measure of the peel strength was the force in N/2.5 cm, which resulted as the average value from five measurements. The test was likewise carried out under standard conditions.

Blushing (Water Resistance)

The test strips were suspended in a water bath. The hazing of the film of adhesive was observed over time. The point in time at which marked hazing became evident was recorded. The longer the time, the better the water resistance.

Results:

Results are set out in the table.

| | | | | Contraction after 3 d of |
|---|---|---|---|---|
| | Peel strength on | Blushing | | storage at 70° C. |
| Copolymer composed | steel after 24 h | (visible | | (gap width by cross- |
| of [pphm] | (N/25 mm) | blushing after) | | cut method) |
| 60 EHA/27 EA/5 VAc/ | 30 | 2 | h | 0.4 mm |
| 5 S/3 AA without | | | | |
| crosslinker | | | | |
| 58.7 EHA/27 EA/5 | 9 | 2 | h | 0.1 mm |
| VAc/5 S/3 AA/1.3 | | | | |
| butanediol diacrylate | | | | |
| 58.7 EHA/27 EA/5 | 1 | 10 | sec | 0.1 mm |
| VAc/5 S/3 AA/1.3 AMA | | | | |
| EHA/EA/VAc/S/AA/1.3 | 11 | 20 | min | 0.1 mm |
| diallyl phthalate | | | | |

EHA: ethylhexyl acrylate
EA: ethyl acrylate
VAc: vinyl acetate
S: styrene
AA: acrylic acid
AMA: allyl methacrylate
BDA: butanediol diacrylate
DAP: diallyl phthalate

1-10. (canceled)

11. An adhesive comprising
a polymer obtainable by free-radical addition polymerization of ethylenically unsaturated monomers and synthesized from at least 60% by weight of principal monomers selected from the group consisting of
C1 to C20 alkyl (meth)acrylates, vinyl esters of carboxylic acids containing up to 20 carbon atoms, vinylaromatics having up to 20 carbon atoms, ethylenically unsaturated nitrites, vinyl halides, vinyl ethers of alcohols containing 1 to 10 carbon atoms, aliphatic hydrocarbons having 2 to 4 carbon atoms and one or two double bonds, and mixtures of these monomers, and
more than 1% by weight of monomers containing at least two nonconjugated polymerizable vinyl groups.

12. An adhesive according to claim 11, wherein the polymer is synthesized from at least 60% by weight of C1 to C20 alkyl (meth)acrylates.

13. An adhesive according to claim 11, wherein the polymer is synthesized from 1.1% to 5% by weight of alkanediol diacrylates or alkanediol dimethacrylates.

14. An adhesive according to claim 11, wherein the polymer is an emulsion polymer.

15. An adhesive according to claim 11, wherein the adhesive contains no further crosslinkers.

16. An adhesive according to claim 11, being a pressure-sensitive adhesive.

17. A method of using an adhesive according to claim 11 for joining two substrates of which at least one is made of PVC.

18. A method of using an adhesive according to claim 11 for joining two substrates of which at least one is made of plasticized PVC.

19. The method according to claim 17, wherein the adhesive is applied to backing material made of unplasticized or plasticized PVC.

20. A self-adhesive article prepared by the method according to claim 19.
